(19) United States
(12) Patent Application Publication
(10) Pub. No.: US 2012/0073145 A1
(43) Pub. Date: Mar. 29, 2012

(54) WEED TRIMMER WITH ELECTRICAL STARTING MECHANISM

(76) Inventor: Jan Gehrki, Williamburg, VA (US)

(21) Appl. No.: 12/889,407

(22) Filed: Sep. 24, 2010

(51) Int. Cl. A01D 34/416

(52) U.S. Cl. 30/277.4

(57) ABSTRACT

The present invention relates to a weed trimmer for trimming a lawn comprising: a gas powered motor, where the motor is mounted one end of a shaft; a cutting assembly, where the cutting assembly is mounted on a second end of a shaft; an electric starter to start the motor; and a means to supply power to the electric starter. In one particular embodiment, the means to supply power may include an AC power cord. The weed trimmer may also include a start button to activate the starter.

### BACKGROUND OF THE INVENTION

1. Field of Invention

The present invention relates to a weed trimmer that includes an electric starter to initiate the gas-powered engine.

2. Description of Related Art

Many individuals use a gas-powered weed trimmer in order to trim weeds and grass edgings when maintaining a lawn. The typical weed trimmer is a handheld device that includes a flexible filament line instead of a blade for cutting weeds or grass in a defined circumference. Many of the weed trimmers are powered by a gas-powered internal combustion engine at the opposite end of a long shaft that includes a cutting end with the engine positioned at the opposite end of the shaft. The weed trimmers typically include handles to hold and manipulate the trimmer during use thereof.

The engine that powers the movement of the trimmer is started through the use of a pull string or reel similar to starting a lawnmower motor. In order to operate the trimmer the user pulls the starting cord with a significant amount of force to initiate the operation of the engine. For some individuals this manual means to start an engine is difficult and especially laborious where repeated starts of the engine is required. It would therefore be advantageous to have a device that could provide an electrical starter on such an engine and therefore obviate the need for the manual pulling of a wound reel to start the engine.

### SUMMARY OF THE INVENTION

The present invention relates to a weed trimmer for trimming a lawn comprising: a gas powered motor, where the motor is mounted one end of a shaft; a cutting assembly, where the cutting assembly is mounted on a second end of a shaft; an electric starter to start the motor; and a means to supply power to the electric starter. In one particular embodiment, the means to supply power may include an AC power cord. The weed trimmer may also include a start button to activate the starter.

### BRIEF DESCRIPTION OF DRAWINGS

FIG. 1 depicts a weed trimmer according to the present invention.

### DETAILED DESCRIPTION

The present invention relates to a weed trimmer that includes electrical pushbutton starter for the gas-powered motor. The electrical starter is integrated into the gas-powered motor and includes an electrical connection to AC outlet. The cord extends from the starter and provides a means for supplying power to the electrical starter integrated with the gas-powered motor. Once the trimmer has been started, the user may continue to operate the weed trimmer without the need for additional starting. Further, the use of the electrical starter obviates the need for a manual pull-cord-type starter.

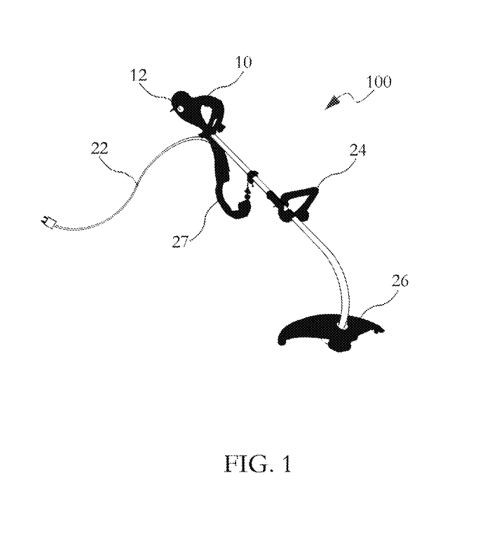

In reference to FIG. 1, a Weed Trimmer 100 according to the present invention is depicted. The Weed Trimmer 100 includes a Cutting End 26 and a gas-powered Engine 12 at the opposite end of the weed trimmer shaft. The Cutting End 26 includes a cover that covers the movement of a filament line that rotate to cut weeds and trim grass as desired. The weed trimmer 10 also includes a forward Handle 24 and a rear Handle 27 to provide a means to maneuver and manipulate the Weed Trimmer 100 as desired.

The gas-powered Engine 10 includes an electrical starter that is initiated by the Start Button 12. The electrical starter starts the engine and therefore eliminates the need for a pull-cord-type starter. Extending from the Engine 10 is a Power Cord 22 that may be connected to an AC outlet. This power cord provides electrical power to the electrical starter integrated with the gas-powered Engine 10. The Starter 12 allows the user to initially start the engine and then proceed with the use of the Trimmer 100.

In one particular embodiment, the Trimmer 100 is used after Engine 10 has been started and the Cord 22 has been disconnected. This method of use allows a maximum amount of mobility and therefore is not restricted by the length of Cord 22. In an alternative embodiment, the Cord 22 may be of sufficient length to allow the user to maneuver a significant distance while using the Trimmer 100.

The advantage of having the electrical starter integrated with the gas-powered engine is that a user may easily start the engine without the use of manual labor and repeated pulling of a pull cord in order to start the engine. In another alternative embodiment a pull cord may be also integrated with the gas-powered engine as the alternative means to start the engine when the electrical power is unavailable. The instant invention has been shown and described in what it considers to be the most practical and preferred embodiments. It is recognized, however, that departures may be made there from within the scope of the invention and that obvious modifications will occur to a person skilled in the art.

What is claimed is:

1. A weed trimmer for trimming a lawn comprising:
a. a gas powered motor, where the motor is mounted one end of a shaft;
b. a cutting assembly, where the cutting assembly is mounted on a second end of a shaft;
c. an electric starter to start the motor; and
d. a means to supply power to the electric starter.

2. The weed trimmer according to claim 1, where said means to supply power includes an AC power cord.

3. The weed trimmer according to claim 1, where the weed trimmer includes a start button to activate the starter.

4. The weed trimmer according to claim 1, where the weed trimmer further includes a front handle and a rear handle extending from the shaft.
